(19) United States
(12) Patent Application Publication
(10) Pub. No.: US 2008/0288776 A1
(43) Pub. Date: Nov. 20, 2008

(54) Security method using virtual keyboard

(75) Inventor: Jang-joong Kim, Seoul (KR)

Correspondence Address: HARNESS, DICKEY & PIERCE, P.L.C., P.O. BOX 828, BLOOMFIELD HILLS, MI, 48303, US

(73) Assignee: ESTsoft Corp.

(21) Appl. No.: 12/151,844

(22) Filed: May 9, 2008

(30) Foreign Application Priority Data
May 17, 2007 (KR) 10-2007-0047957

(51) Int. Cl. H04L 9/30; H04L 9/32

(52) U.S. Cl. 713/168

(57) ABSTRACT

The present invention relates to a security method using a virtual keyboard, and more specifically, to a security method using a virtual keyboard, in which a user may input information through the virtual keyboard using a mouse when the user logs into a web server by inputting an identification (ID) and a password, and the inputted password is transmitted to the web server after being encrypted, so that personal information is prevented from being leaked by a hacking program and a safe connection is established. According to the present invention, risk of personal information leakage that can be occurred when an ID and a password are inputted through a keyboard may be greatly reduced, and it is effective in that even when a symmetric key is leaked, which is least expected, decipher of data is prevented by maintaining security of a private key.

### BACKGROUND OF THE INVENTION

1. Field of the Invention

The present invention relates to a security method using a virtual keyboard, and more specifically, to a security method using a virtual keyboard, in which a user may input information through the virtual keyboard using a mouse when the user logs into a web server by inputting an identification (ID) and a password, and the inputted password is transmitted to the web server after being encrypted, so that personal information is prevented from being leaked by a hacking program and a safe connection is established.

2. Background of the Related Art

Recently, along with the rapid advancements in computers, the Internet and the like, important businesses such as Internet banking or stock exchanges through home trading systems (HTS) can be done using the computers. However, by taking malicious advantage of the computers and the Internet, there are increased cases where spyware or a key stroke logger is installed in a user terminal to detect and record all data inputted by a user through a data input device such as a keyboard and leak out the recorded data through an e-mail or a web site address.

For example, a malicious hacker uses a key logger program to leak personal information. The key logger program should be previously installed in a user computer, and the program has a structure of recording important personal information, such as identification (ID), password, resident registration number, account number and the like, inputted by a user through a keyboard into a log and transmitting the personal information to the hacker at a predetermined time. Therefore, when such a malicious program is installed in the user computer by the hacker and the user uses Internet banking, sensitive personal information of the user is leaked to the hacker as it is.

A variety of techniques is used to solve such cases of malicious uses. Generally, a virus vaccine, a spyware removal tool, a personal computer (PC) firewall, and the like are installed in a PC, and malicious programs such as the spyware and the like are detected and removed periodically or in real-time. However, malicious programs modified differently from existing programs may not be blocked until the malicious programs are acquired and analyzed and a method for removing the malicious programs is found.

In order to complement such weak points on security, techniques of using devices other than a keyboard as an input means are disclosed, and one of the techniques is a method of inputting personal information using a virtual keyboard.

The virtual keyboard implements a simulated keyboard on a software basis in the user terminal, and if a user inputs specific characters using the cursor of a mouse on the simulated keyboard, the same effect as inputting the characters using a keyboard may be obtained.

In case where a conventional keyboard is used, as soon as a key is pressed, an input value is inputted into the user terminal through a keyboard interface, and the input value goes through an encryption process by a control unit. If a hacker may intercept a data value inputted into the keyboard interface from the keyboard, the hacker may know the input value before the input value is encrypted.

However, in case where a virtual keyboard is used, it is advantageous in that an input value according to a click of a mouse may not be known, and thus security may be enhanced. However, there is still a risk that an inputted ID and password may be exposed to hackers at the moment when they are transmitted to a web server.

### SUMMARY OF THE INVENTION

Therefore, the present invention has been made in view of the above problems, and it is an object of the present invention to provide a security method using a virtual keyboard, in which input values inputted by a user by clicking a mouse or the like on the virtual keyboard are immediately encrypted, and the encrypted input values are transmitted to a web server, thereby reducing a risk of leaking personal information when the information is inputted through a keyboard.

Another object of the invention is to provide a security method using a virtual keyboard, in which a password inputted by a user through the virtual keyboard is encrypted using a symmetric key stored in a user terminal and the symmetric key is encrypted using a public key, and then the encrypted password and symmetric key are transmitted to a web server, thereby further reducing possibility of leakage of the password.

To accomplish the above objects, according to one aspect of the present invention, there is provided a security method a virtual keyboard, which encrypts contents inputted through the virtual keyboard executed in a user terminal, the method comprising the steps of: displaying the virtual keyboard on a software basis on the user terminal when the user terminal connects to a web server through the Internet; allowing the user terminal to encrypt a password using a symmetric key stored in the user terminal if an ID and the password are inputted in a method of clicking a keyboard formed on the virtual keyboard using a cursor of a mouse; allowing the web server to transmit a specific public key to the user terminal if a request for transmitting the public key is inputted from the user terminal; allowing the web server to decrypt the symmetric key using a private key corresponding to the specific public key if the user terminal encrypts the symmetric key using the specific public key and transmits the ID and the encrypted password and the symmetric key to the web server; allowing the web server to decrypt the password using the decrypted symmetric key; allowing the web server to transmit the ID and the decrypted password to an authentication server; and allowing the web server to transmit a result of user authentication to the user terminal to display the result on the user terminal if the result of user authentication is received by the web server from the authentication server.

The virtual keyboard displayed on the user terminal includes an ID input window, a password input window, and a keyboard adapted to express one or more characters or numerals.

The authentication server stores personal information of a user who uses the ID inputted through the user terminal and authenticates whether the user is a valid user using the ID and the decrypted password received from the web server.

The virtual keyboard displayed on the user terminal additionally includes a rearrangement button, and if a user clicks on the rearrangement button using the cursor of the mouse, the order of arrangement of the characters or numerals displayed on the keyboard is changed.

### BRIEF DESCRIPTION OF THE DRAWINGS

FIG. 1 is a flowchart illustrating a flow of a security method of the present invention.

FIG. 2 is a conceptual view showing the configuration of a virtual keyboard according to an embodiment of the present invention.

### DETAILED DESCRIPTION OF THE PREFERRED EMBODIMENT

Hereinafter, a security method using a virtual keyboard (hereinafter, referred to as a security method) according to an embodiment of the present invention will be described in detail with reference to the accompanying drawings.

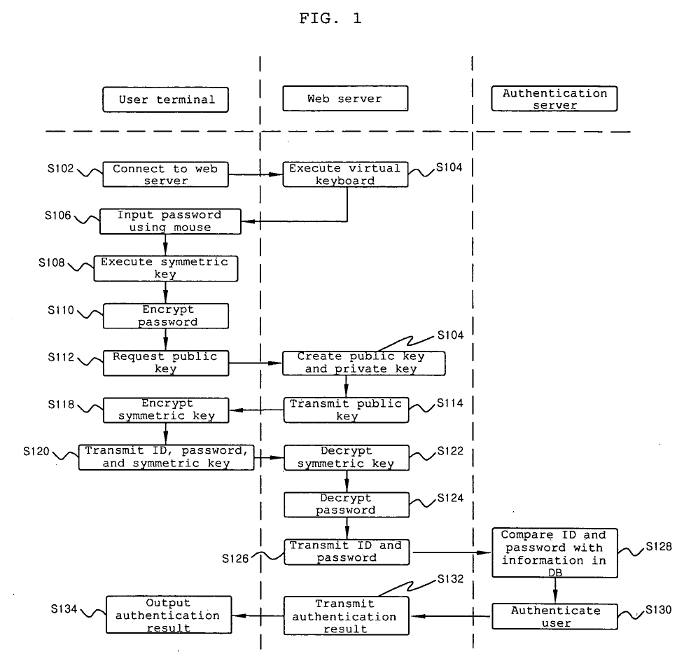

FIG. 1 is a flowchart illustrating a flow of a security method of the present invention.

All of a user terminal 100, a web server 200, and an authentication server 300 shown in FIG. 1 are connected through the Internet (not shown).

The web server 200 of the present invention is a management system of a web site that provides online games, Internet banking, electronic government services, and the like. General users should input their information and obtain user authentication in order to use such services, and the security method of the present invention may be used in the process of such authentication.

The authentication server 300 is a processing system of various personal information certification authorities. A certification authority is an institute that determines whether information is secure in a network and issues and manages public keys (private keys and symmetric keys) used for encrypting and decrypting a variety of messages.

The authentication server 300 stores personal information of users, such as public keys of the users, expiry dates of certificates or the like, user names, user IDs, passwords, and the like.

First, a user connects to the web server 200 of a service provider company in order to use services such as online games, Internet banking, or the like S102. The connection to the web server 200 is established through the user terminal 100 connected to the Internet.

If a request for providing a service that requires a user authentication is inputted from the user terminal 100, the web server 200 executes a virtual keyboard to display the virtual keyboard on a web browser of the user terminal 100 (S104).

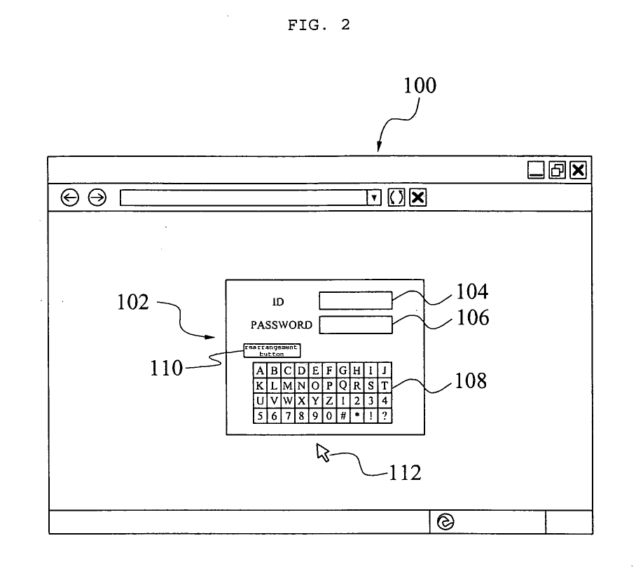

FIG. 2 is a conceptual view showing the configuration of a virtual keyboard 102 according to an embodiment of the present invention. As shown in FIG. 2, the virtual keyboard 102 of the present invention is displayed on a web browser executed in the user terminal 100. Accordingly, it is advantageous in that a separate interface program does not need to be executed to configure an ID and password input screen.

The virtual keyboard 102 of the present invention includes an ID input window 104, a password input window 106, a keyboard 108, and a rearrangement button 110.

Korean characters, English letters, numerals, and the like are displayed on the keyboard 108, and a user may input an ID and a password by clicking specific characters using an input device such as a mouse.

The rearrangement button 110 randomly changes the order of arrangement of the keyboard 108 to avoid a hacking method that reads movements of a mouse as coordinate values and grasps characters inputted by a user. It is preferable that the user changes the order of arrangement of the keyboard 108 before inputting an ID or a password by pressing the rearrangement button 110 once or twice.

The user selects either the ID input window 104 or the password input window 106 using the mouse cursor 112, moves the mouse cursor 112 to the keyboard 108, and inputs an ID or a password (S106).

If the ID or the password is inputted, the user terminal 100 encrypts the ID or the password by executing a previously stored symmetric key (S108 and S110). Although it is described to encrypt only the password in the present invention, the ID may also be encrypted as needed.

The symmetric key means a case where an algorithm (a key) used for encryption is the same as an algorithm used for decryption. Typical symmetric keys include the data encryption standard (DES) protocol having encryption data of 56 bits and the 3DES protocol having encryption data of 168 bits. Such a symmetric key algorithm and an encryption module may be previously stored in the user terminal 100, or a method of receiving the symmetric key algorithm and the encryption module whenever the user terminal 100 connects to the web server 200 and executing the algorithm in the user terminal 100 may be used.

Since the encryption and decryption method described in the specification of the present invention is a general algorithm that is open to the public before the date of applying the present invention, detailed descriptions of the method will be omitted to avoid repetition.

When encryption of the inputted password is completed, the user terminal 100 requests the web server 200 to transmit a public key (S112).

The public key is also referred to as a non-symmetric key, and keys used for encryption and decryption are different from each other unlike the symmetric key algorithm. A pair of keys is used for encryption and decryption in the public key algorithm, and this pair of keys comprises a public key and a private key.

The public key is an open key whoever can use. The private key is a key stored in a hard disk drive (HDD), a smart card, or the like, and security of the private key is maintained so that only the subjects who made the key pair may use the key.

When data is encrypted using the public key, the data may be decrypted only with the private key created in pair with the corresponding public key. Accordingly, even when the public key is leaked, since data may not be decrypted without the private key corresponding to the public key, security is enhanced compared with the symmetric key algorithm.

Since the encryption and decryption technique using the public key algorithm also uses a previously disclosed technique, it will not be described in detail.

If a request for transmitting a public key is inputted from the user terminal 100, the web server 200 creates and stores a public key and a private key corresponding to the public key and transmits the public key to the user terminal (S114 and S116).

The user terminal 100 encrypts a symmetric key using the public key transmitted from the web server 200 (S118). The symmetric key is a key used to encrypt the password inputted by the user using the virtual keyboard 102, which is a key needed to decrypt the password by the web server 200. The symmetric key is encrypted using the public key before being transmitted to the web server 200, and thus security is further enhanced.

The user terminal 100 transmits the ID, password, and symmetric key to the web server 200 through the Internet (S120). At this point, the password and the symmetric key are encrypted respectively using the symmetric key (the key stored in the user terminal) and the public key (the key transmitted from the web server).

The web server 200 decrypts the transmitted symmetric key using the private key (S122). The private key used for decrypting the symmetric key is a key corresponding to the public key transmitted to the user terminal 100.

Then, the web server 200 decrypts the password using the decrypted symmetric key (S124).

The web server 200 transmits the ID inputted from the user terminal 100 and the decrypted password to the authentication server 300 to request user authentication (S126)

The authentication server 300 performs a user authentication process by comparing user's personal information stored in its own database (DB) with the transmitted information (S128 and S130).

A result of the user authentication is transmitted to the user terminal 100 through the web server 200, and the authentication process is completed (S132 and S134). Then, the user may enjoy an on-line game at the web sever 200 or uses Internet banking.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

According to the present invention, risk of personal information leakage that can be occurred when an ID and a password are inputted through a keyboard may be greatly reduced, and it is effective in that even when a symmetric key is leaked, which is least expected, decipher of data is prevented by maintaining security of a private key.

What is claimed is:

1. A security method using a virtual keyboard, which encrypts contents inputted through the virtual keyboard executed in a user terminal, the method comprising the steps of:
displaying the virtual keyboard on a software basis on the user terminal when the user terminal connects to a web server through the Internet;
allowing the user terminal to encrypt a password using a symmetric key stored in the user terminal if an ID and the password are inputted in a method of clicking a keyboard formed on the virtual keyboard using a cursor of a mouse;
allowing the web server to transmit a specific public key to the user terminal if a request for transmitting the public key is inputted from the user terminal;
allowing the web server to decrypt the symmetric key using a private key corresponding to the specific public key if the user terminal encrypts the symmetric key using the specific public key and transmits the ID and the encrypted password and the symmetric key to the web server;
allowing the web server to decrypt the password using the decrypted symmetric key;
allowing the web server to transmit the ID and the decrypted password to an authentication server; and
allowing the web server to transmit a result of user authentication to the user terminal to display the result on the user terminal if the result of user authentication is received by the web server from the authentication server.

2. The method according to claim 1, wherein the virtual keyboard displayed on the user terminal includes an ID input window, a password input window, and a keyboard adapted to express one or more characters or numerals.

3. The method according to claim 1, wherein the authentication server stores personal information of a user who uses the ID inputted through the user terminal, and authenticates whether the user is a valid user using the ID and the decrypted password received from the web server.

4. The method according to claim 2, wherein the virtual keyboard displayed on the user terminal additionally includes a rearrangement button, and if a user clicks on the rearrangement button using the cursor of the mouse, the order of arrangement of the characters or numerals displayed on the keyboard is changed.
